(19) United States
(12) Patent Application Publication
(10) Pub. No.: US 2007/0187120 A1
(43) Pub. Date: Aug. 16, 2007

(54) Gardening tool

(76) Inventor: Jui-Ju Yeh, Taipei (TW)

Correspondence Address: BIRCH STEWART KOLASCH & BIRCH, PO BOX 747, FALLS CHURCH, VA, 22040-0747, US

(21) Appl. No.: 11/344,087

(22) Filed: Feb. 1, 2006

(51) Int. Cl. A01B 1/00

(52) U.S. Cl. 172/371

(57) ABSTRACT

A gardening tool has a handle, a spine, a neck and a too head. The handle has an open slot defined longitudinally through the handle. The spine is mounted in and fully extends through the open slot in the handle. The neck is welded securely to the spine. The tool head is welded to the neck. The welded structure of the spine, neck and tool head and the fully engagement of the handle and the spine enhance structural strength of the whole gardening tool, which improves durability of the gardening tool.

### BACKGROUND OF THE INVENTION

1. Field of the Invention

The present invention relates to a gardening tool, and more particularly to a gardening tool that has a handle, a tool head and a spine attached to the tool head and fully extending through and mounted in the handle to improve structural strength and durability of the gardening tool.

2. Description of Related Art

Gardening tools, particularly small hand-held gardening tools, such as gardening trowels and spading forks, are employed by gardeners for digging, scooping soil or moving garden prunings, weeds and other organic material.

A conventional hand-held gardening tool has a tool head, a neck and a handle. The tool head has a front end and a rear end. The neck is crooked and is attached to the front end of the tool head and has a front end and a rear end. The front end of the neck is welded to the rear end of the tool head by welding. The handle is attached to the neck and has a front end, a rear end and a mounting hole. The mounting hole is defined in the front end of the handle, is attached to and holds the rear end of the neck with an adhesive so the neck is securely held in the handle.

However, operating the hand-held gardening tool with strenuous effort easily leads to disassembly of the hand-held gardening tool because the engagement section between the neck and the handle with the adhesive has a weak structure and is always where a break begins.

To overcome the shortcomings, the present invention provides a gardening tool to mitigate or obviate the aforementioned problems.

### SUMMARY OF THE INVENTION

The main objective of the invention is to provide a gardening tool that has a handle, a tool head and a spine attached to the tool head and fully extending through and mounted in the handle to improve structural strength and durability of the gardening tool.

A gardening tool in accordance with the present invention comprises a handle, a spine, a neck and a too head.

The handle has an open slot defined longitudinally through the handle.

The spine is mounted in and fully extends through the open slot in the handle.

The neck is welded securely to the spine.

The tool head is welded to the neck.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a gardening tool in accordance with the present invention with a spade as the tool head;

FIG. 2 is a perspective view of the first embodiment of the gardening tool in accordance with the present invention with a spading fork as the tool head;

FIG. 3 is an exploded perspective view of the gardening tool in FIG. 1;

FIG. 4 is a top view in partial section of the gardening tool in FIG. 1;

FIG. 5 is a side view in partial section of the gardening tool in FIG. 4; and

FIG. 6 is an exploded perspective view of second embodiment of a gardening tool in accordance with the present invention.

### DETAILED DESCRIPTION OF THE PREFERRED EMBODIMENT

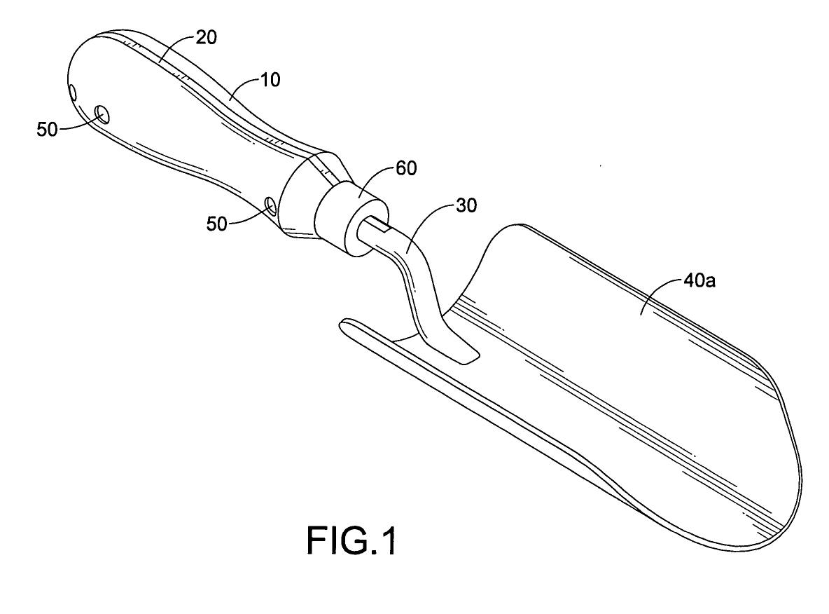

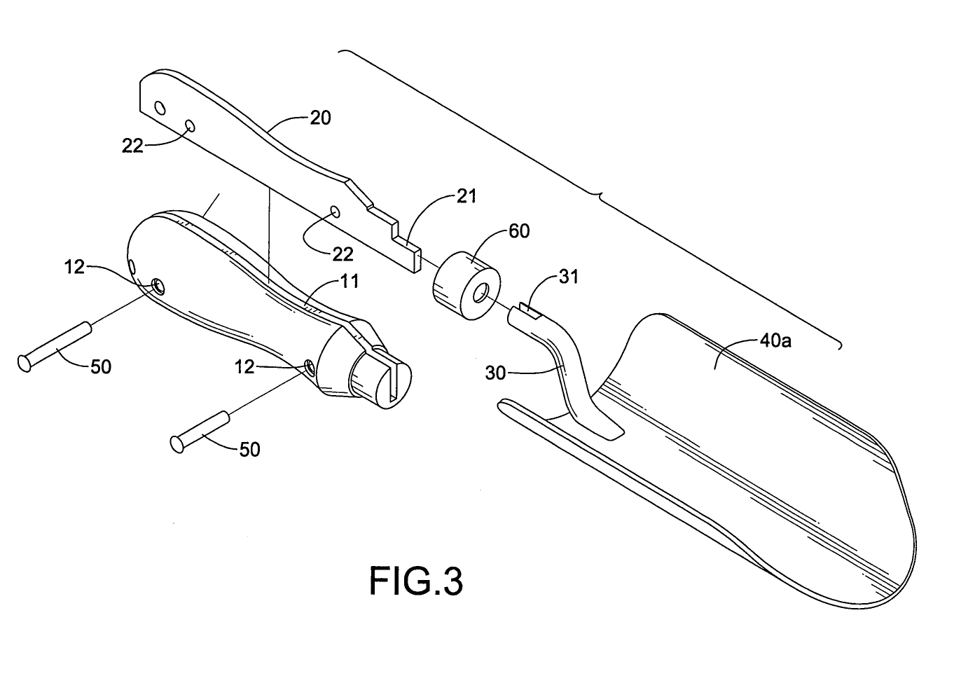

With reference to FIGS. 1 and 3, a hand-held gardening tool in accordance with the present invention has a handle (10), a spine (20), a neck (20), a tool head, multiple fasteners (50) and a crown (60).

The handle (10) is made of wood or plastic and has a front end, a rear end, an open slot (11) and multiple mounting holes (12). The open slot (11) is defined longitudinally through the handle (10). The mounting holes (12) are defined transversely through the handle (10).

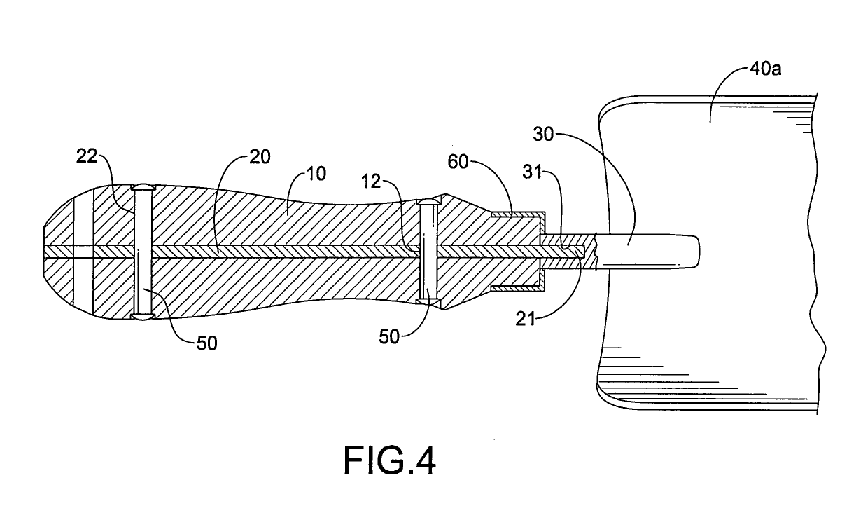

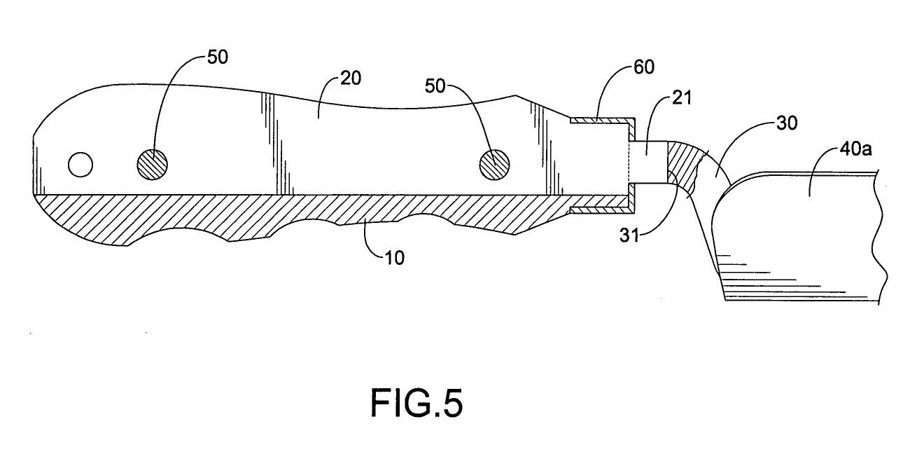

With further reference to FIGS. 4 and 5, the spine (20) is made of metal, is mounted securely in and fully extends longitudinally through the open slot (11) in the handle (10) and has a front end, a rear end, a mounting protrusion (21) and multiple mounting holes (22). The mounting protrusion (21) extends from the front end of the spine (20). The mounting holes (22) are defined transversely through the spine (20) and are aligned respectively with mounting holes (12) in the handle (10).

The neck (30) is made of metal, is attached securely to the spine (20) and has a front end (not numbered), a rear end (not numbered) and a mounting recess (31). The mounting recess (31) is defined longitudinally in the rear end of the neck (30), is welded securely to and holds the front end of the spine (20).

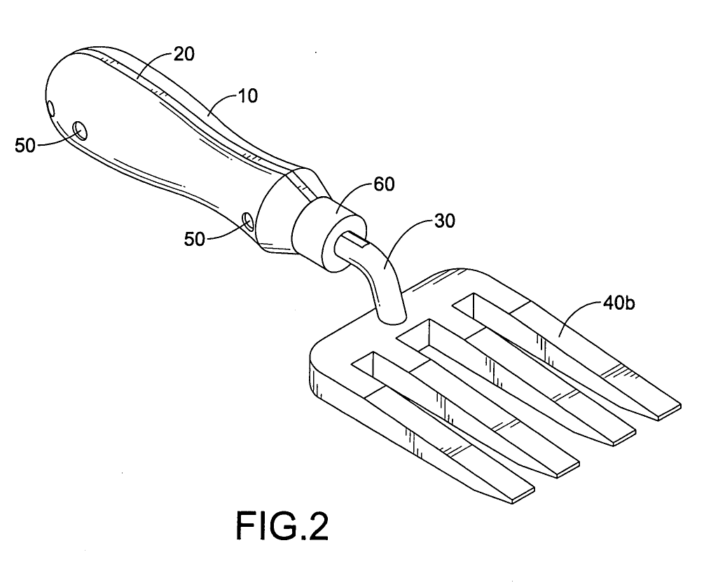

With further reference to FIG. 2, the tool head is made of metal, is attached securely to the neck (30), may be a spade (40a), a spading fork (40b), a rake (not shown) or the likes as used for garden cultivation and has a front end and a rear end. The rear end of the tool head is welded securely to the front end of the neck (30).

The fasteners (50) are attached securely to the handle (10) and the spine (20) to securely hold the spine (20) in the handle (10). The fasteners (50) maybe rivets or screws that correspond to and are mounted respectively through the mounting holes (12, 22) in the handle (10) and the spine (20). Because the tool head, neck (30) and spine (20) are welded integrally to form a single piece and the spine fully extends through and is held in the handle (10), the whole structure of the gardening tool is strong and is difficult to break in a specific section on the tool.

In a first embodiment of the gardening tool in accordance with the present invention, the crown (60) is mounted around and covers the front ends of the handle (10) and the spine (20) to further improve the engagement between the neck (30), spine (20) and the handle (10).

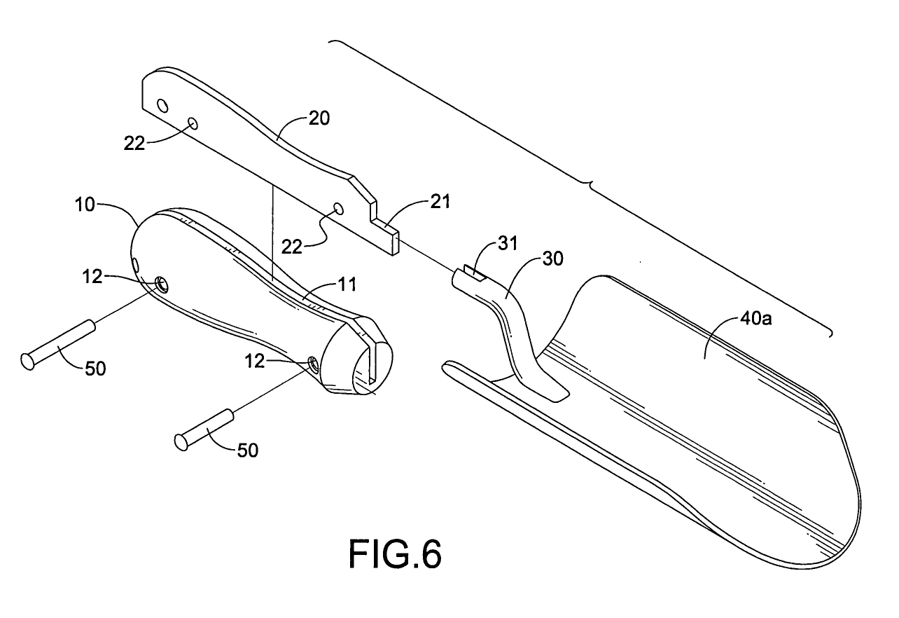

With reference to FIG. 6, a second embodiment of the gardening tool is similar to the first embodiment and is implemented without the crown (60).

The welded structure of the spine (20), neck (30) and the tool head (30) and a fully engagement of the handle (10) and spine (30) greatly enhance the strength of the whole gardening tool. Therefore, the gardening tool is durable and hardly broken when bearing a person's strenuous strength.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A gardening tool comprising:
a handle having
a front end;
a rear end; and
an open slot defined longitudinally through the handle;
a spine being made of metal, being mounted securely in and fully extending longitudinally through the open slot in the handle and having
a front end;
a rear end; and
a mounting protrusion extending from the front end of the spine;
a neck being made of metal, attached securely to the spine and having
a front end;
a rear end; and
a mounting recess defined longitudinally in the rear end of the neck, welded securely to and holding the front end of the spine;
a tool head made of metal, attached securely to the neck and having a front end and a rear end welded securely to the front end of the neck; and
multiple fasteners attached securely to the handle and the spine to securely hold the spine in the handle.

2. The gardening tool as claimed in claim 1 further comprising a crown mounted around and covering the front ends of the handle and the spine.

3. The gardening tool as claimed in claim 2, wherein:
the handle further has multiple mounting holes defined through the handle;
the spine further has multiple mounting holes defined through the spine and aligned respectively with the mounting holes in the handle; and
the fasteners correspond to and are mounted respectively through the mounting holes in the handle and the spine.
